(19) United States
(12) Patent Application Publication
(10) Pub. No.: US 2007/0247996 A1
(43) Pub. Date: Oct. 25, 2007

(54) OPTICAL PICKUP AND OPTICAL DISC APPARATUS

(75) Inventors: Satoshi Kawakita, Tokyo (JP); Motoo Aiba, Tokyo (JP); Kyu Kanno, Miyagi (JP); Jin Sato, Miyagi (JP); Takatoshi Yamada, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 11/695,801

(22) Filed: Apr. 3, 2007

(30) Foreign Application Priority Data
Apr. 21, 2006 (JP) P2006-118370

(51) Int. Cl. G11B 7/00

(52) U.S. Cl. 369/112.05; 369/112.23

(57) ABSTRACT

An optical pickup includes: a light source that emits first, second and third wavelengths of optical beam; and an objective lens unit including a diffraction element whose one surface includes a first diffraction pattern where the first wavelength is diffracted while the second and third wavelengths pass through and whose other surface includes a second diffraction pattern where the second wavelength is diffracted while the first and third wavelengths pass through; and an objective lens that collects the optical beam from the diffraction element, wherein the second and third wavelengths traveling through the objective lens unit are on the optical axis of the objective lens unit while the first wavelength traveling through the objective lens unit have an angle with respect to the optical axis; and the first diffraction pattern is located at a position so as to minimize aberration of the first wavelength of optical beam.

### CROSS REFERENCES TO RELATED APPLICATIONS

The present invention contains subject matter related to Japanese Patent Application JP2006-118370 filed in the Japanese Patent Office on Apr. 21, 2006, the entire contents of which being incorporated herein by reference.

### BACKGROUND OF THE INVENTION

1. Field of the Invention

The present invention relates to an optical pickup and optical disc apparatus, and is preferably applied to an optical pickup that supports a plurality of types of optical discs, for example.

2. Description of Related Art

In recent years, there is an optical disc device that supports a plurality of types of optical discs: “Blu-ray Disc (Registered Trademark)” (BD) along with well-known formats such as Compact Disc (CD) and Digital Versatile Disc (DVD).

The optical disc device chooses one of the following types of optical beam in accordance with the format of an optical disc inserted: approximately 780 nm wavelength of optical beam for CD, around 650 nm wavelength of optical beam for DVD or about 405 nm wavelength of optical beam for BD.

By the way, it is desirable that the optical disc device be equipped with an objective lens that supports the three types of wavelengths to be simplified and downsized: The objective lens is installed in an optical pickup that emits an optical beam to an optical disc.

However, different wavelengths of optical beams are used for CD, DVD and BD formats. In addition, their protection layers are different in thickness (or the distances from lower surfaces of the optical discs to their signal recording surfaces are different). Moreover, their numerical apertures for objective lens are different.

Accordingly, it is difficult to design the objective lens that supports the three types of wavelengths. It is difficult to obtain one with good characteristics because of lower transmission efficiency and aberration of optical beams and the like.

Therefore, correcting the aberration of optical beams is one way to cope with the above problem (see Jpn. Pat. Laid-open Publication No. 2005-302270, for example): a diffraction element that selectively diffracts particular wavelengths of optical beams may be used along with the objective lens.

On one and the other surfaces of the diffraction element, a diffraction grating for optical beam of CD (also referred to as a “CD-type optical beam”) and a diffraction grating for optical beam of DVD (also referred to as a “DVD-type optical beam”) are respectively formed such that their optical centers lie on the same line. Before getting into the objective lens, the CD-type optical beam and the DVD-type optical beam are diffracted by the diffraction elements to have appropriate aberration for correcting. Accordingly, even though the objective lens has been designed to be suitable for optical beam of BD (also referred to as a “BD-type optical beam”), the objective lens also works well for the CD- and DVD-type optical beams.

### SUMMARY OF THE INVENTION

By the way, the above optical pickup supporting a plurality of types of optical discs is often designed to be simplified and downsized: The optical pickup therefore usually includes a laser diode that emits two or three wavelengths of laser beam.

That kind of laser diode usually includes in a package a plurality of diode elements each of which emits a different wavelength of laser beam. Those diode elements emit laser beams from different light-emitting points. Accordingly, the optical axes of the laser beams emitted from the laser diodes vary according to the wavelengths.

As a result, if the diffraction element having the diffraction gratings on its surfaces is designed such that the axis of the diffraction element matches the optical axis of a laser beam, the optical axis of the other laser beam may be tilted with respect to the diffraction element after being converged by a collimator lens. Accordingly, the aberration caused by the objective lens may not be corrected appropriately.

The present invention has been made in view of the above points and is intended to provide an optical pickup and optical disc apparatus with good characteristics for a plurality of types of optical discs.

In one aspect of the present invention, an optical pickup includes: a light source that emits first, second and third wavelengths of optical beam; and an objective lens unit including a diffraction element whose one surface includes a first diffraction pattern where the first wavelength of optical beam is diffracted while the second and third wavelengths of optical beam pass through and whose other surface includes a second diffraction pattern where the second wavelength of optical beam is diffracted while the first and third wavelengths of optical beam pass through; and an objective lens that collects the first, second and third wavelengths of optical beam from the diffraction element, wherein the second and third wavelengths of optical beam that travels through the objective lens unit are on the optical axis of the objective lens unit while the first wavelength of the optical beam that travels through the objective lens unit have an angle with respect to the optical axis of objective lens unit; and the first diffraction pattern is located at a position with respect to the optical axis of the objective lens unit so as to minimize aberration of the first wavelength of optical beam after being diffracted and collected by the first diffraction pattern and the objective lens.

In this manner, the first diffraction pattern that diffracts the first wavelength of optical beam is located at a position with respect to the optical axis of the objective lens unit so as to minimize aberration of the first wavelength of optical beam after being diffracted and collected by the first diffraction pattern and the objective lens. Accordingly, the first diffraction pattern is located slightly away from the optical axis. This eliminates the aberration arising from the optical beam traveling diagonally through the objective lens unit. Thus, the optical pickup provides good characteristics for a plurality of types of optical disc.

In another aspect of the present invention, an optical disc apparatus includes: an optical pickup that emits a first, second or third wavelength of optical beam to an optical disc, the optical pickup including: a light source that emits the first, second and third wavelengths of optical beam; and an objective lens unit including a diffraction element whose one surface includes a first diffraction pattern where the first wavelength of optical beam is diffracted while the second and third wavelengths of optical beam pass through and whose other surface includes a second diffraction pattern where the second wavelength of optical beam is diffracted while the first and third wavelengths of optical beam pass through; and an objective lens that collects the first, second and third wavelengths of optical beam from the diffraction element, wherein the second and third wavelengths of optical beam that travels through the objective lens unit are on the optical axis of the objective lens unit while the first wavelength of the optical beam that travels through the objective lens unit have an angle with respect to the optical axis of objective lens unit; and the first diffraction pattern is located at a position with respect to the optical axis of the objective lens unit so as to minimize aberration of the first wavelength of optical beam after being diffracted and collected by the first diffraction pattern and the objective lens.

In this manner, the first diffraction pattern that diffracts the first wavelength of optical beam is located at a position with respect to the optical axis of the objective lens unit so as to minimize aberration of the first wavelength of optical beam after being diffracted and collected by the first diffraction pattern and the objective lens. Accordingly, the first diffraction pattern is located slightly away from the optical axis. This eliminates the aberration arising from the optical beam traveling diagonally through the objective lens unit. Thus, the optical disc apparatus provides good characteristics for a plurality of types of optical disc.

As mentioned above, the first diffraction pattern that diffracts the first wavelength of optical beam is located at a position with respect to the optical axis of the objective lens unit so as to minimize aberration of the first wavelength of optical beam after being diffracted and collected by the first diffraction pattern and the objective lens. Accordingly, the first diffraction pattern is located slightly away from the optical axis. This eliminates the aberration arising from the optical beam traveling diagonally through the objective lens unit. Thus, the optical pickup and the optical disc apparatus provide good characteristics for a plurality of types of optical disc.

The nature, principle and utility of the invention will become more apparent from the following detailed description when read in conjunction with the accompanying drawings in which like parts are designate by like reference numerals or characters.

### BRIEF DESCRIPTION OF THE DRAWINGS

In the accompanying drawings:

FIG. 1 is a block diagram illustrating the overall configuration of an optical disc apparatus;

FIG. 2 is a schematic diagram illustrating the configuration of an optical pickup;

FIG. 3 is a schematic perspective view of an objective lens unit;

FIG. 4 is a schematic diagram illustrating light paths inside the objective lens unit;

FIGS. 5A to 5C are schematic diagrams illustrating the configuration of a diffraction element;

FIGS. 6A to 6F are schematic diagrams illustrating a method for manufacturing the diffraction element; and

FIG. 7 is a schematic diagram illustrating a shift arrangement of diffraction grating.

### DETAILED DESCRIPTION OF PREFERRED EMBODIMENTS

An embodiment of the present invention will be described in detail with reference to the accompanying drawings.

(1) Configuration of Optical Disc Apparatus

(1-1) Overall Configuration of Optical Disc Apparatus

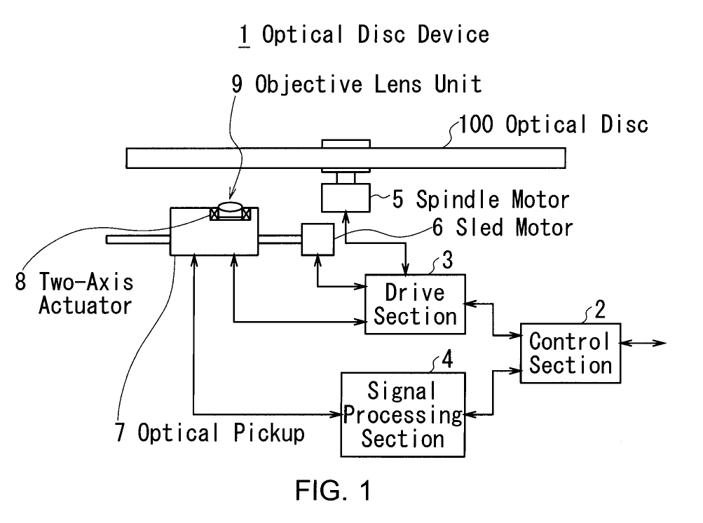

In FIG. 1, the reference numeral 1 denotes an optical disc apparatus with a diffraction element according to an embodiment of the present invention. The optical disc apparatus 1 reproduces signals from an optical disc 100 which is one of the following formats: Compact Disc (CD) type, Digital Versatile Disc (DVD) type or “Blu-ray Disc (Registered Trademark)” (BD) type.

A control section 2 takes overall control of the optical disc apparatus 1. After the optical disc 100 is inserted into the optical disc apparatus 1, the control section 2 controls, in response to a playback command or the like from external devices (not shown), a drive section 3 and a signal processing section 4 to reproduce information from the optical disc 100.

The drive section 3 under the control of the control section 2 controls a spindle motor 5 to rotate the optical disc 100 at appropriate speeds. The drive section 3 also controls a sled motor 6 to bring an optical pickup 7 in a direction of tracking or the radial direction of the optical disc 100. The drive section 3 also controls a two-axis actuator 8 to bring an objective lens unit 9 in a direction of focusing or close to the optical disc 100, or in a direction of tracking away from the optical disc 100.

During those processes, the signal processing section 4 controls the optical pickup 7 to emit an optical beam to the trucks of the optical disc 100 through the objective lens unit 9. After detecting the reflection, the signal processing section 4 reproduces a signal based on the detected result, and then supplies the reproduced signal to the external devices (not shown) through the control section 2.

The optical pickup 7 supports three types of wavelength when emitting the optical beam through the objective lens unit 9; the wavelength of 780 nm of the optical beam for the CD-type optical disc 100c; the wavelength of 650 nm of the optical beam for the DVD-type optical disc 100d; and the wavelength of 405 nm of the optical beam for the BD-type optical disc 100b.

When reproducing signals from the optical disc 100, the optical disc apparatus 1 chooses, in accordance with the type of the optical disc 100, one of the above beams and then emits it to the optical disc 100.

(1-2) Configuration of Optical Pickup

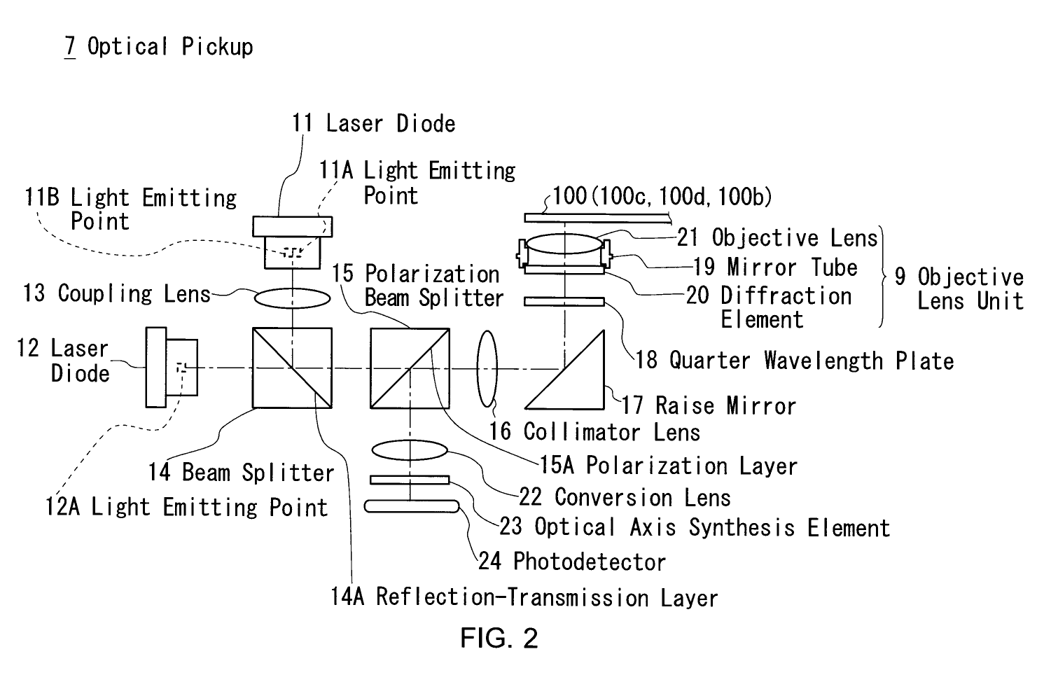

As shown in FIG. 2, the optical pickup 7 includes sources of the optical beams: a laser diode 11 supporting two types of wavelengths that emits the optical beams of 780 and 650 nm wavelengths for the CD- and DVD-types, respectively; and a laser diode 12 to emit the optical beam of 405 nm wavelengths for the BD-type. The optical beam for CD will be also referred to as a “CD-type optical beam Lc” while the optical beam for DVD and BD will be also referred to as a “DVD-type optical beam Ld” and a “BD-type optical beam Lb”, respectively.

A coupling lens 13 changes the optical magnification of the optical beam from the laser diode 11.

The optical beam of particular wavelengths is reflected on a reflection-transmission layer 14A of a beam splitter 14 while the optical beam with other wavelengths passes through the reflection-transmission layer 14A; the CD-type optical beam Lc of around 780 nm and the DVD-type optical beam Ld of about 650 nm are reflected on the reflection-transmission layer 14A while the BD-type optical beam LD of about 405 nm passes through the reflection-transmission layer 14A.

The optical beam with particular polarization angles is reflected on a polarization layer 15A of a polarization beam splitter 15 while the optical beam of other polarization angles passes through the polarization layer 15A; the incident optical beam from the beam splitter 14 passes through the polarization layer 15A while the incident optical beam from a collimator lens 16, whose polarization angles have been adjusted, is reflected on the polarization layer 15A.

The collimator lens 16 collimates the divergent light, which is the incident optical beam from the polarization beam splitter 15, and transforms the collimated optical beam from a raise mirror 17 into convergent light.

The horizontal optical beam from the collimator lens 16 is reflected on the raise mirror 17 and then travels in the vertical direction or a direction perpendicular to the optical disc 100; the vertical optical beam from a quarter wavelength plate 18 is reflected on the raise mirror 17 and then travels in the horizontal direction.

As for a part of the optical beam, its phase is delayed by one quarter of a wavelength through the quarter wavelength plate 18. This transforms the optical beam from the raise mirror 17 from linearly polarized light into circularly polarized light while it transforms the optical beam from the objective lens unit 9 from circularly polarized light into linearly polarized light.

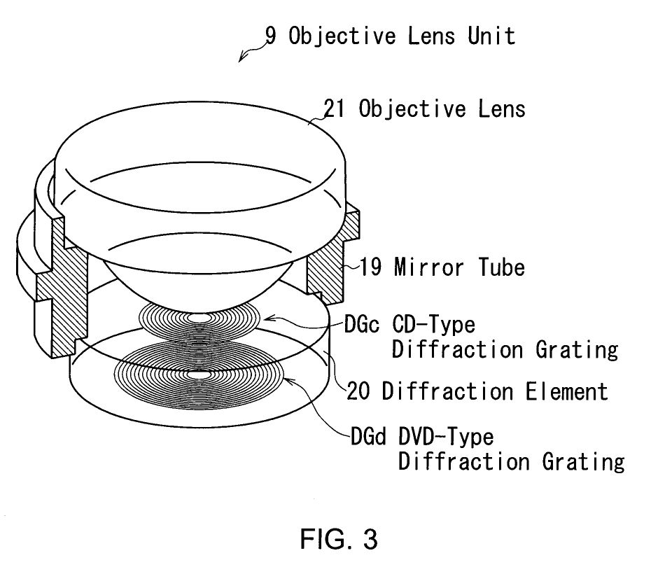

As shown in FIG. 3 where a part of the cutting surface of the objective lens unit 9 is illustrated, a plane disc-shaped diffraction element 20 is attached to the bottom of a mirror tube 19. The objective lens 21 is placed between the top and middle areas of the mirror tube 19; the objective lens 21 includes a disc-shaped section whose size is almost the same as the diffraction element 20 and a smaller-diameter spindle-shaped section which is formed on the under surface of the disc-shaped section.

The objective lens unit 9 transforms the collimated optical beam from the quarter wavelength plate 18 into convergent light through the diffraction element 20 and the objective lens 21 to bring it to a focal point on the optical disc 100.

In the optical pickup 7, the optical beam diverged on the signal recording surface of the optical disc 100 is collimated through the objective lens 21 and diffraction element 20 of the objective lens unit 8. The optical beam is then transformed from circularly polarized light to linearly polarized light through the quarter wavelength plate 18. The optical beam then travels in the horizontal direction to the polarization beam splitter 15 after being reflected on the raise mirror 17. Before getting into the polarization beam splitter 15, the optical beam is transformed from collimated light to convergent light through the collimator lens 16.

In this case, the optical beam with particular polarization angles is reflected on the polarization layer 15A of the polarization beam splitter 15. After that, the optical beam gets into a conversion lens 22.

The conversion lens 22 changes the optical magnification of the CD-type optical beam Lc, the DVD-type optical beam Ld and the BD-type optical beam Lb. An optical axis synthesis element 23 substantially makes the optical axes of the CD-type optical beam Lc and DVD-type optical beam Ld from the laser diode 11 and that of the BD-type optical beam Lb from the laser diode 12 all together.

On the surface of a photodetector 24 that is designed to receive the optical beam from the optical axis synthesis element 23 via the conversion lens 22, a plurality of detection cells in a predetermined shape is formed. The detection cells detect the optical beam and then photoelectric-convert it. The detection cells subsequently supply resultant detection signals to the signal processing section 4 (FIG. 1).

The signal processing section 4 performs a predetermined calculation process and other processes using the detection signals from the photodetector 24 (FIG. 2) to obtain reproduction RF signals, and then performs, based on the reproduction RF signals, predetermined decoding and demodulation processes and the like to produce reproduction signals.

In addition, the signal processing section 4 (FIG. 1) performs, using the detection signals from the photodetector 24 (FIG. 2), a predetermined calculation process and other processes to produce drive control signals such as trucking error signals and focus error signals, and then supplies the drive control signals to the control section 2. As a result, the control section 2 performs, through the drive section 3, control processes such as trucking and focus control to adjust the optical beam to the optical disc 100. In this manner, the reproduction signals are appropriately produced.

(1-2-1) CD-Type Optical Disc

When the control section 2 (FIG. 1) determines, based on a predetermined disc type determination method, that the optical disc 100 is CD-type (100c), the control section 2 controls the laser diode 11 of the optical pickup 7 (FIG. 2) to emit the CD-type optical beam Lc, or divergent light, from the light emitting point 11A to the beam splitter 14 via the coupling lens 13.

The CD-type optical beam Lc is reflected on the reflection-transmission layer 14A of the beam splitter 14, and then passes through the polarization beam splitter 15. The CD-type optical beam Lc is subsequently collimated by the collimator lens 16, and then reflected on the raise mirror 17 to travel in the vertical direction. The CD-type optical beam Lc is subsequently converted by the quarter wavelength plate 18 from linearly polarized light into circularly polarized light, and then reaches the objective lens unit 9.

The objective lens unit 9 converts, through the diffraction element 20 and the objective lens 21, the CD-type optical beam Lc from the quarter wavelength plate 18 into convergent light, and leads it to the focus point on the signal recording surface of the CD-type optical disc 100c.

The objective lens unit 9 subsequently collimates, through the objective lens 21 and the diffraction element 20, the divergent CD-type optical beam Lc which is the reflection from the signal recording surface of the CD-type optical disc 100c, and then leads it to the quarter wavelength plate 18.

After that, in the optical pickup 7, the CD-type optical beam Lc is converted by the quarter wavelength plate 18 from circularly polarized light to linearly polarized light, and then is reflected on the raise mirror 18 to travel in the horizontal direction. The CD-type optical beam Lc is subsequently converted by the collimator lens 16 from collimated light to convergent light, and then reflected on the polarization layer 15A of the polarization beam splitter 15. After that, the CD-type optical beam Lc passes through the conversion lens 22 and the optical axis synthesis element 23 to reach the photodetector 24.

The detection cells of the photodetector 24 detect the CD-type optical beam Lc, and transmit the resultant detection signals to the signal processing section 4 (FIG. 1).

The signal processing section 4 produces, based on the detection signals, the reproduction RF signals, and then generates, based on the reproduction RF signals, the reproduction signals. On the other hand, the signal processing section 4 produces the drive control signals such as trucking error signals and focus error signals.

(1-2-2) DVD-Type Optical Disc

When the control section 2 (FIG. 1) determines, based on a predetermined disc type determination method, that the optical disc 100 is DVD-type (100d), the control section 2 controls the laser diode 11 of the optical pickup 7 (FIG. 2) to emit the DVD-type optical beam Ld, or divergent light, from the light emitting point 11B to the beam splitter 14 via the coupling lens 13.

In a similar way to that of the CD-type optical disc 100c, the DVD-type optical beam Ld is reflected on or passes through the following components: the coupling lens 13, the beam splitter 14, the polarization beam splitter 15, the collimator lens 16, the raise mirror 17 and the quarter wavelength plate 18. After that, the DVD-type optical beam Ld is converted into convergent light through the diffraction element 20 and objective lens 21 of the objective lens unit 9, and then is focused on the signal recording surface of the DVD-type optical disc 100d.

After that, in a similar way to that of the CD-type optical disc 100c, the objective lens 21 and diffraction element 20 of the objective lens unit 9 collimate the divergent DVD-type optical beam Ld, which is the reflection from the signal recording surface of the DVD-type optical disc 100d. The DVD-type optical beam Ld is subsequently reflected on or passes through the following components: the quarter wavelength plate 18, the raise mirror 17, the collimator lens 16, the polarization beam splitter 15, the conversion lens 22 and the optical axis synthesis element 23. As a result, the DVD-type optical beam Ld reaches the photodetector 24.

In a similar way to that of the CD-type optical disc 100c, the detection cells of the photodetector 24 detect the DVD-type optical beam Ld, and transmit the resultant detection signals to the signal processing section 4 (FIG. 1).

The signal processing section 4 produces, based on the detection signals, the reproduction RF signals, and then generates, based on the reproduction RF signals, the reproduction signals. On the other hand, the signal processing section 4 produces the drive control signals such as trucking error signals and focus error signals.

(1-2-3) BD-Type Optical Disc

When the control section 2 (FIG. 1) determines, based on a predetermined disc type determination method, that the optical disc 100 is BD-type (100b), the control section 2 controls the laser diode 12 of the optical pickup 7 (FIG. 2) to emit the BD-type optical beam Lb, or divergent light, from the light emitting point 12A to the beam splitter 14.

In this case, the BD-type optical beam Lb passes through the reflection-transmission layer 14A of the beam splitter 14, and goes into the polarization beam splitter 15.

After that, in a similar way to that of the CD-type optical disc 100c, the BD-type optical beam Lb is reflected on or passes through the following components: the polarization beam splitter 15, the collimator lens 16, the raise mirror 17 and the quarter wavelength plate 18. After that, the BD-type optical beam Lb is converted into convergent light through the objective lens 21 of the objective lens unit 9, and then is focused on the signal recording surface of the BD-type optical disc 100b.

By the way, in this case, the objective lens unit 9 allows the BD-type optical beam Lb to pass through the diffraction element 20. It means that the diffraction element 20 does not diffract the BD-type optical beam Lb (described later).

After that, in a similar way to that of the CD-type optical disc 100c, the objective lens 21 of the objective lens unit 9 collimates the divergent BD-type optical beam Lb, which is the reflection from the signal recording surface of the BD-type optical disc 100b. The BD-type optical beam Lb is subsequently reflected on or passes through the following components: the quarter wavelength plate 18, the raise mirror 17, the collimator lens 16, the polarization beam splitter 15, the conversion lens 22 and the optical axis synthesis element 23. As a result, the BD-type optical beam Lb reaches the photodetector 24.

In a similar way to that of the CD-type optical disc 100c, the detection cells of the photodetector 24 detect the BD-type optical beam Lb, and transmit the resultant detection signals to the signal processing section 4 (FIG. 1).

The signal processing section 4 produces, based on the detection signals, the reproduction RF signals, and then generates, based on the reproduction RF signals, the reproduction signals. On the other hand, the signal processing section 4 produces the drive control signals such as trucking error signals and focus error signals.

In this manner, the optical pickup 7 supports the CD-type optical disc 100c, the DVD-type optical disc 100d and the BD-type optical disc 100b: with the objective lens unit 9, the CD-type optical beam Lc, the DVD-type optical beam Ld and the BD-type optical beam Lb are focused on the signal recording surface of the optical disc 100 appropriately, and their reflection are correctly detected by the photodetector 24.

(1-3) Configuration of Objective Lens Unit

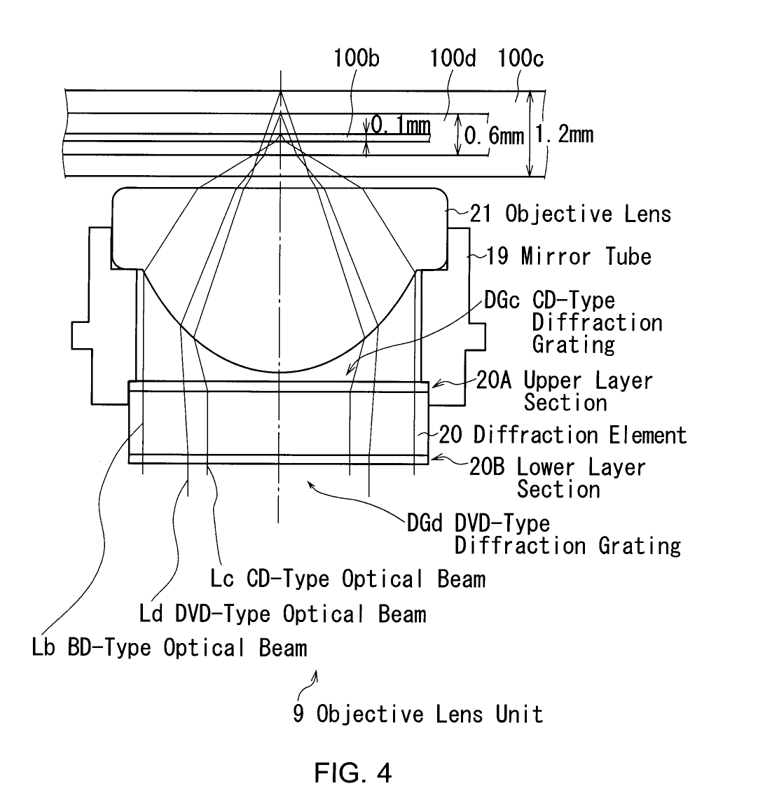

FIG. 4 is an enlarged sectional view of the CD-type optical disc 100c, the DVD-type optical disc 100d, the BD-type optical disc 100b and the objective lens unit 9.

By the way, FIG. 4 does not illustrate the two-axis actuator 8 (FIG. 1) which is attached to the objective lens unit 9.

As for CD-, DVD- and BD-types, the following are standardized for compatibility: the wavelengths of optical beam to read out information; numerical apertures for collecting the optical beam; and the thickness of the optical discs 100 between the lower surface and the signal recording surface, or the thickness of the cover layer.

In reality, the CD-type optical disc is standardized in the following manner: the wavelength is approximately 780 nm; numerical apertures are approximately 0.45; and the thick of the cover layer is 1.2 mm. The DVD-type optical disc is standardized in the following manner: the wavelength is approximately 650 nm; numerical apertures are approximately 0.6; and the thick of the cover layer is 0.6 mm. The BD-type optical disc is standardized in the following manner: the wavelength is approximately 405 nm; numerical apertures are approximately 0.85; and the thick of the cover layer is 0.1 mm.

In addition, as for the CD-type optical beam Lc, the DVD-type optical beam Ld and the BD-type optical beam Lb, their focal distances, the distances between the objective lens 21 and their focal points, are different due to the characteristics of the objective lens 21.

Accordingly, in the optical disc apparatus 1, the two-axis actuator 8 (FIG. 1) adjusts the distance between the objective lens unit 9 and the optical disc 100 to have the optical beam focused on the signal recording surface of the optical discs: the two-axis actuator 8 appropriately positions the objective lens unit 9 with respect to the optical disc 100 fixed at predetermined position.

By the way, for ease of explanation, FIG. 4 illustrates the optical discs 100 whose positions are being adjusted with respect to the fixed objective lens unit 9, resulting in different distances between the objective lens 9 and each optical disc's lower surface. In addition, FIG. 4 only illustrates the cover layers of the CD-type optical disc 100c, DVD-type optical disc 100d and BD-type optical disc 100b.

Considering the relative intensity of the BD-type optical beam Lb, the numerical apertures for BD-type and the like, the objective lens 21 is mainly designed for the BD-type optical beam Lb rather than the CD-type optical beam Lc and the DVD-type optical beam Ld.

Accordingly, when the collimated BD-type optical beam Lb reaches the lower surface of the objective lens 21 of the objective lens unit 9, the objective lens 21 converts this incident BD-type optical beam Lb into convergent light to have it focused on the signal recording surface of the BD-type optical disc 100b.

However, the objective lens 21 is designed for the BD-type optical beam Lb as mentioned above: if the collimated CD-type optical beam Lc or DVD-type optical beam Ld gets into the objective lens 21 via its lower surface, it may cause an aberration while the objective lens 21 converts it into convergent light. As a result, the optical beam may not be focused on the signal recording surface of the optical disc 100 appropriately.

Accordingly, the diffraction element 20 of the objective lens unit 9 only diffracts the CD-type optical beam Lc and DVD-type optical beam Ld to supply them to the objective lens 21 as non-collimated light. On the other hand, as the collimated BD-type optical beam comes in, the diffraction element 20 supplies it to the objective lens 21 as collimated light.

As a matter of fact, on an upper layer section 20A of the diffraction element 20, a diffraction grating for CD (also referred to as “CD-type diffraction grating”) DGc, or hologram, is formed to diffract only the CD-type optical beam Lc, not the DVD-type optical beam Ld and the BD-type optical beam Lb. As shown in FIG. 4, the CD-type optical beam Lc is slightly diffracted outward by the CD-type diffraction grating DGc.

That is to say, the upper layer section 20A of the diffraction element 20 allows the DVD-type optical beam Ld and the BD-type optical beam Lb to pass through it while selectively diffracting the CD-type optical beam Lc. In other words, the upper layer section 20A of the diffraction element 20 is designed to only correct the aberration for the CD-type optical beam Lc.

After that, as shown in FIG. 4, the CD-type optical beam Lc from the diffraction element 20 is refracted through the lower and upper surfaces of the objective lens 21. This converts the CD-type optical beam Lc into convergent light. In this manner, the objective lens unit 9 corrects the aberration for the CD-type optical beam Lc, and leads the CD-type optical beam Lc from the objective lens 21 to a focal point on the signal recording surface of the CD-type optical disc 100c.

In addition, on a lower layer section 20B of the diffraction element 20, a diffraction grating for DVD (also referred to as “DVD-type diffraction grating”) DGd, or hologram, is formed to diffract only the DVD-type optical beam Ld, not the CD-type optical beam Lc and the BD-type optical beam Lb. As shown in FIG. 4, the DVD-type optical beam Ld is slightly diffracted outward by the DVD-type diffraction grating DGd.

That is to say, the lower layer section 20B of the diffraction element 20 allows the CD-type optical beam Lc and the BD-type optical beam Lb to pass through it while selectively diffracting the DVD-optical beam Ld. In other words, the lower layer section 20B of the diffraction element 20 is designed to only correct the aberration for the DVD-type optical beam Ld.

After that, as shown in FIG. 4, the DVD-type optical beam Ld from the diffraction element 20 is refracted through the lower and upper surfaces of the objective lens 21. This converts the DVD-type optical beam Ld into convergent light. In this manner, the objective lens unit 9 corrects the aberration for the DVD-type optical beam Ld, and leads the DVD-type optical beam Ld from the objective lens 21 to a focal point on the signal recording surface of the DVD-type optical disc 100d.

In this manner, in the objective lens unit 9, the upper layer section 20A of the diffraction element 20 only corrects the aberration for the CD-type optical beam Lc by diffracting it while the lower layer section 20B of the diffraction element 20 only corrects the aberration for the DVD-type optical beam Ld by diffracting it. That can appropriately lead the CD-type optical beam Lc, the DVD-type optical beam Ld or the BD-type optical beam Lb to focal points of the signal recording surface of the CD-type optical disc 100c, the DVD-type optical disc 100d or the BD-type optical disc 100b even after they pass through the objective lens 21 designed for the BD-type optical beam Lb.

(1-4) Configuration of Diffraction Element

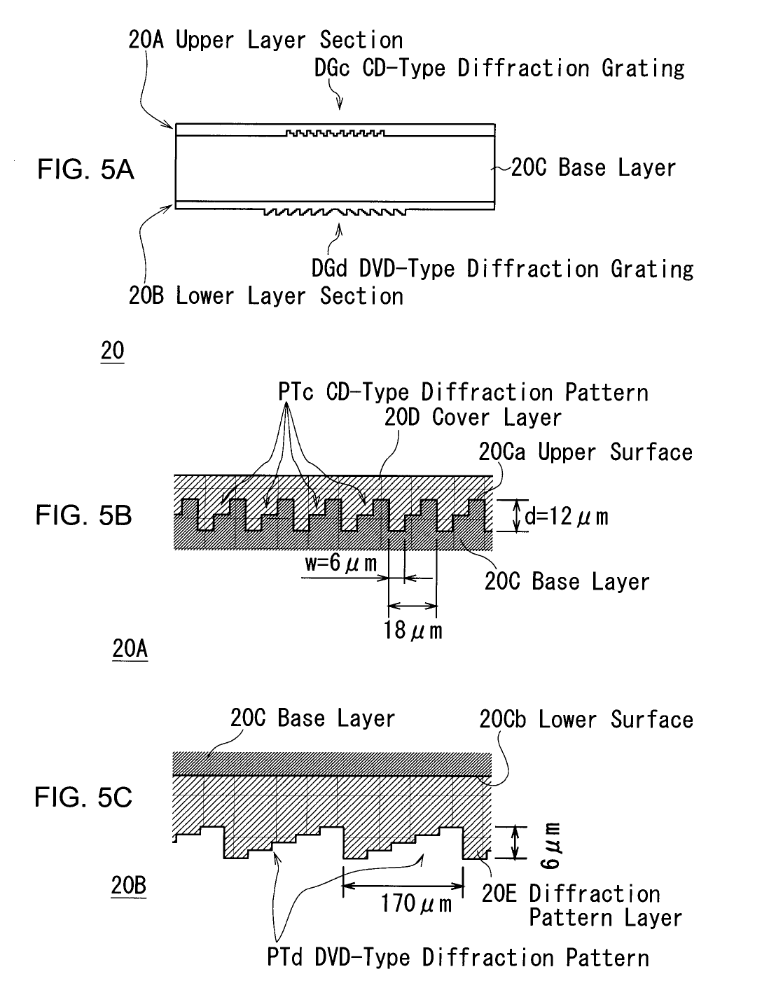

As shown in FIG. 5A, the diffraction element 20 includes a flat, disc-shaped base layer 20C. Its upper layer section 20A includes the CD-type diffraction grating DGc while its lower layer section 20B includes the DVD-type diffraction grating DGd, as mentioned above.

The base layer 20C is for example made from transparent synthetic resin with a predetermined refractive index. Its interface to air or other materials can diffract the optical beam.

FIG. 5B is an enlarged sectional view of the upper layer section 20A. The CD-type diffraction pattern PTc is formed on an upper surface 20c of the base layer 20C: the CD-type diffraction pattern PTc includes a plurality of step-like protruding parts located at certain intervals. The CD-type diffraction pattern PTc is covered by a cover layer 20D that is for example made from transparent cured resin.

The step-like CD-type diffraction pattern PTc (also referred to as a “first diffraction pattern”) includes three steps for each protruding part: the height of the protruding parts from bottom to top is 12 μm; and the interval of protruding parts, or the distance between one protruding part to the adjoining protruding part, is 18 μm if it is the shortest one. As shown in FIG. 3, the CD-type diffraction pattern PTc is concentrically formed on the upper surface of the diffraction element 20 within one-half radius from the center.

The cover layer 20D (also referred to as a “third member”) is made from a certain material whose refraction index is different from that of the base layer 20C (the base layer 20C is also referred to as a “first member”). A lower surface of the cover layer 20D is attached to the CD-type diffraction pattern PTc (or the first diffraction pattern) without no space between them. An upper surface of the cover layer 20D is substantially flat.

In this manner, the upper layer section 20A of the diffraction element 20 includes the step-like CD-type diffraction pattern PTc whose protruding portions are located at certain intervals on the upper surface 20Ca of the base layer 20C. On the CD-type diffraction pattern PTc, the cover layer 20D is formed: the refraction index of the cover layer 20D is different from that of the base layer 20C. Accordingly, the upper layer section 20A diffracts the optical beam of particular wavelengths while allowing the optical beam of other wavelengths to pass through it. In this case, the diffraction element 20 includes the CD-type diffraction grating DGc that only diffracts the CD-type optical beam Lc (the CD-type optical beam Lc is also referred to as an “optical beam of a first wavelength”).

FIG. 5C is an enlarged sectional view of the lower layer section 20B. A diffraction pattern layer 20E including a DVD-type diffraction grating DGd is attached to a flat lower surface 20Cb of the base layer 20C.

The diffraction pattern layer 20E (also referred to as a “second member”) is made from transparent resin whose refractive index is substantially the same as that of the base layer 20 (or first member). The step-like protruding portions are formed at certain intervals on its bottom side as the DVD-type diffraction pattern PTd. The lower surface of the diffraction pattern layer 20E is an interface to air because it is not covered by any materials.

The step-like DVD-type diffraction pattern PTd (also referred to as a “second diffraction pattern”) includes five steps for each protruding part: the height of the protruding parts from bottom to top is 6 μm; and the interval of protruding parts, or the distance between one protruding part to the adjoining protruding part, is 170 μm. As shown in FIG. 3, the DVD-type diffraction pattern PTd is concentrically formed on the lower surface of the diffraction element 20 within two-thirds radius from the center.

In this manner, the lower layer section 20B of the diffraction element 20 includes the step-like DVD-type diffraction pattern PTd (or a second diffraction pattern) whose protruding portions are located at certain intervals on the diffraction pattern layer 20E attached to the lower surface of the base layer 20C. The lower layer section 20B diffracts the optical beam of particular wavelengths while allowing the optical beam of other wavelengths to pass through it. In this case, the diffraction element 20 includes the DVD-type diffraction grating DGd that only diffracts the DVD-type optical beam Ld (the DVD-type optical beam Ld is also referred to as an “optical beam of a second wavelength”).

(2) Method for Manufacturing Diffraction Elements

A production method for the diffraction elements 20 will be described. As mentioned above, the diffraction pattern layer 20E is attached to the lower surface of the base layer 20C.

The base layer 20 is produced by injection molding in the following manner: transparent resin with a predetermined refractive index, such as polyolefin resin, is injected into a mold. As shown in FIG. 5B, the CD-type diffraction pattern PTc is formed on the upper surface 20Ca of the base layer 20C.

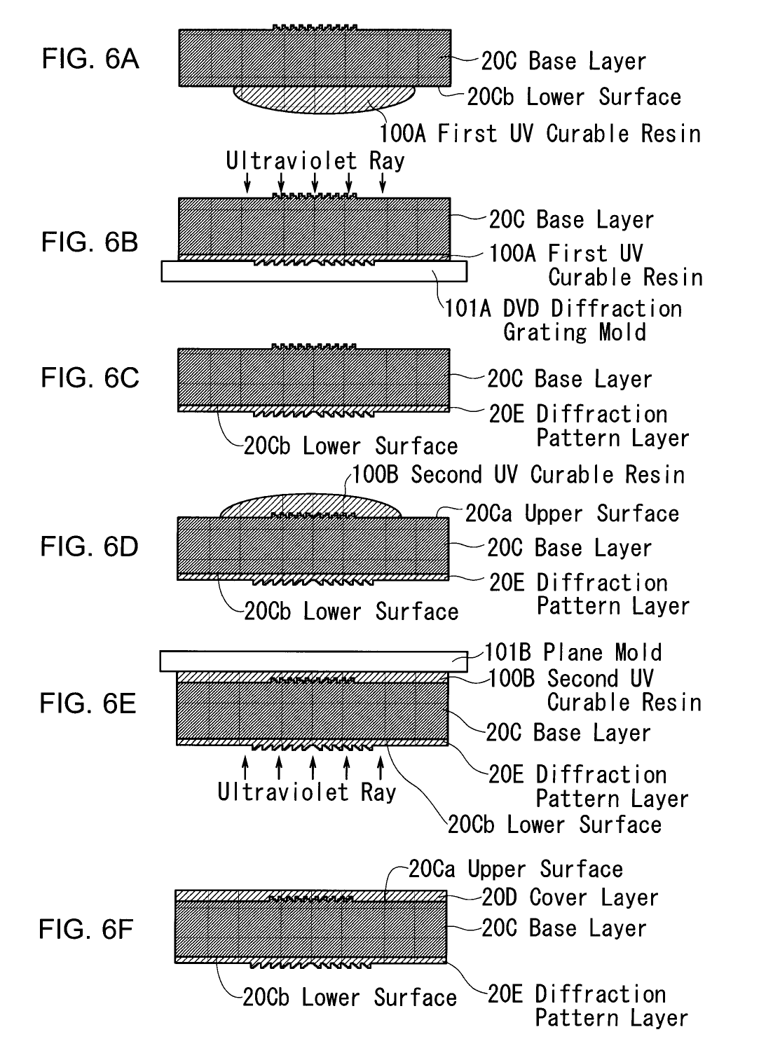

The method of manufacturing the diffraction element 20 is this: as shown in FIG. 6A, a first UV curable resin 100A whose refraction index is almost the same as that of the resin from which the inject-molded base layer 20C is made is applied to the lower surface 20Cb of the base layer 20C.

Then, as shown in FIG. 6B, a DVD diffraction grating mold 101A, which is the inverse of the shape of the DVD-type grating pattern PTd (FIG. 5C), is put on the UV curable resin 101A on the lower surface 20Cb. An ultraviolet ray source (not shown) then emits ultraviolet rays to the upper surface of the base layer 20C to solidify the resin. As a result, the first UV curable resin 100A is solidified in the DVD diffraction grating mold 101A. In this manner, as shown in FIG. 6C, the diffraction pattern layer 20E having the DVD-type diffraction pattern PTd is formed on the lower surface 20Cb of the base layer 20C with no space between them.

After the diffraction pattern layer 20E is formed, as shown in FIG. 6D, a second UV curable resin 100B whose refraction index is different from that of the resin from which the base layer 20C is made is applied to the upper surface 20Ca of the base layer 20C: the resin of the base layer 20C has the refraction index of n_{BASE}=1.5 while that of the second UV curable resin 100B is n_{UV2}=1.6, for example.

Then, as shown in FIG. 6E, a plane surface of a plane mold 101B is put on the second UV curable resin 100B to have the second UV curable resin 100B covering the CD-type diffraction pattern PTc (FIG. 5C) formed on the upper surface 20Ca of the base layer 20C with no space between them. Subsequently, an ultraviolet ray is applied to the lower surface of the base layer 20C to solidify the second UV curable resin 100B. This produces the plane cover layer 20E on the CD-type diffraction pattern PTc (FIG. 6F).

(3) Shift Arrangement of Diffraction Patterns

As mentioned above, the optical pickup 7 emits the CD-type optical beam Lc and the DVD-type optical beam Ld from the laser diode 11 that supports two kinds of wavelengths. Since the position of the light emitting point 11A that emits the CD-type optical beam Lc is different from that of the light emitting point 11B that emits the DVD-type optical beam Ld, the optical axis of the CD-type optical beam Lc slightly deviates from that of the DVD-type optical beam Ld.

Accordingly, if the optical axis of the CD-type optical beam Lc or the DVD-type optical beam Ld is matched with the optical axis of the optical pickup 7 (this optical axis extends from the beam splitter 14 to the objective lens unit 9), the other optical axis may deviates from the optical axis of the optical pickup 7.

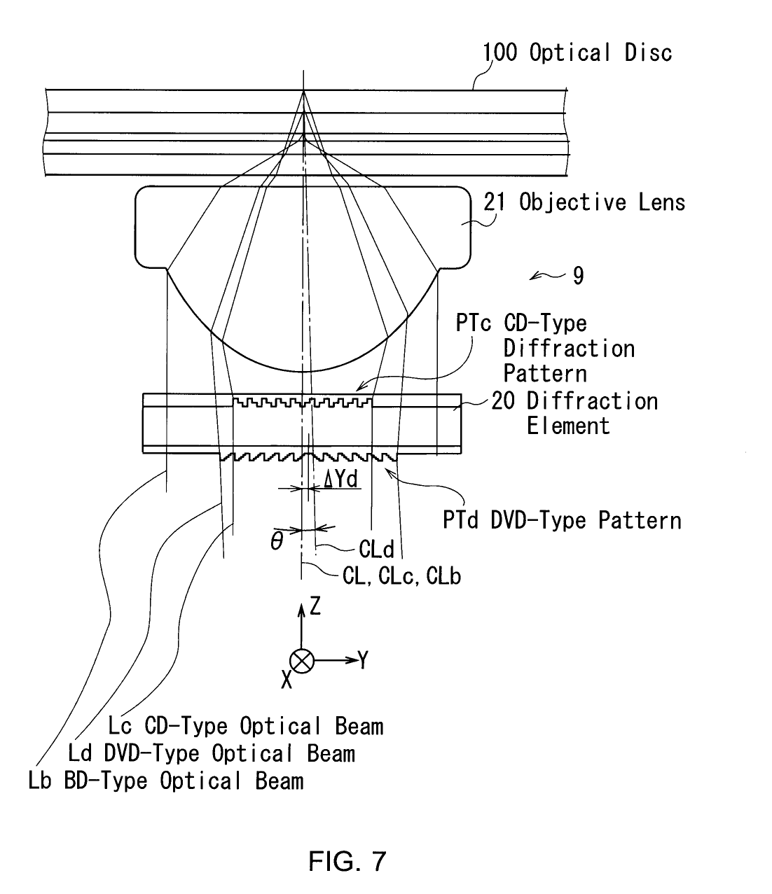

For example, if the optical axis of the CD-type optical beam Lc is superimposed on that of the optical pickup 7, the optical axis of the DVD-type optical beam Ld may deviate from the center of the collimator lens 16. As shown in FIG. 7, after being transformed into convergent light by the collimator lens 16, the optical axis CLd of the DVD-type optical beam Ld that gets into the objective lens unit 9 makes an incident angle θ with respect to the optical axis CL of the objective lens unit 9 (also with respect to the optical axis CLc of the CD-type optical beam Lc and the optical axis CLb of the BD-type optical beam Lb): the incident angle θ varies according to the amount of optical-axis deviation.

Since the DVD-type optical beam Ld diagonally gets into the objective lens 9, that causes coma aberration to the DVD-type optical beam Ld collected by the objective lens unit 9. By the way, because the CD-type optical beam Lc and the BD-type optical beam Lb enter perpendicularly to the objective lens unit 9, there is no coma aberration.

According to an embodiment of the present invention, to minimize the coma aberration arising from the optical beam deviated after being diffracted by the diffraction pattern and being collected by the objective lens 21, the optical center of the diffraction pattern is sifted from the optical axis of the objective lens unit 9.

For example, in FIG. 7, Z represents the direction of the optical axis CL of the objective lens unit 9; Y represents the direction perpendicular to the Z direction on the plane containing the optical axis CL and the optical axis CLd of the DVD-type optical beam Ld being diagonally entered; and X represents the direction perpendicular to both the Z and Y directions. In addition, ΔYd represents the amount of shift of the center of the DVD-type diffraction pattern PTd from the optical axis CL of the objective lens unit 9 in the Y axis direction.

To minimize the coma aberration of the DVD-type optical beam Ld collected by the objective lens unit 9, ΔYd is determined by experiments or simulation. When producing the diffraction pattern layer 20D on the lower surface of the base layer 20C (FIG. 6), the DVD diffraction grating mold 101A is located such that the center of the DVD-type grating pattern PTd is sifted from the center of the base layer 20C by ΔYd. This produces the diffraction element 20 by which the coma aberration arising from the deviated DVD-type optical beam Ld is minimized.

(4) Operation and Effect

The optical pickup 7 with the above configuration selects, in accordance with the type of the optical disc 100 inserted, one of the following diodes: the laser diode 12 that emits the BD-type optical beam Lb or the laser diode 11 that emits the DVD-type optical beam Ld and the CD-type optical beam Lc.

In this case, out of the two types of optical beam emitted from the laser diode 11, the DVD-type optical beam Ld travels diagonally through the objective lens unit 9 because of the position of the light emitting point. Accordingly, the DVD-type diffraction pattern PTd is shifted from the optical axis CL of the objective lens unit 9 (or the center of the diffraction grating 20) to minimize the coma aberration arising from the DVD-type optical beam Ld collected by the objective lens unit 9.

Accordingly, the optical pickup 7 provides good characteristics in light collection not only for the CD-type optical beam Lc and BD-type optical beam Lb whose axes are being matched with the optical axis of the optical pickup but also for the DVD-type optical beam Ld that travels diagonally through the objective lens unit 9. This means that the optical pickup and the optical disc apparatus can provide good characteristics for CD, DVD and BD.

(5) Other Embodiments

In the above-noted embodiments, out of the two types of optical beam emitted from the laser diode 11, the optical axis of the CD-type optical beam Lc matches with the optical axis of the optical pickup 7; the DVD-type optical beam Ld enters the objective lens unit 9 diagonally due to deviation of the optical axis; and the DVD-type diffraction pattern PTd is shifted from the center of the diffraction grating 20 to minimize the coma aberration. However the present invention is not limited to this. The following may be applied: out of the two types of optical beam emitted from the laser diode 11, the optical axis of the DVD-type optical beam Ld matches with the optical axis of the optical pickup 7; the CD-type optical beam Lc enters the objective lens unit 9 diagonally due to deviation of the optical axis; and the CD-type diffraction pattern PTc is shifted from the center of the diffraction grating 20 to minimize the coma aberration.

Moreover, in the above-noted embodiments, when producing the diffraction pattern layer 20D (made of UV curable resin) on the injection-molded base layer 20 containing the CD-type diffraction pattern PTc, the optical center of the DVD-diffraction pattern PTd is located on a position different from that of the CD-type diffraction pattern PTc to minimize the coma aberration arising from the DVD-type optical beam Lb. However the present invention is not limited to this. Other configuration of the diffraction element 20 may be applied insofar as the DVD-type diffraction pattern PTd is located at the position that allows minimizing the coma aberration of the DVD-type optical beam Ld: the CD-type diffraction pattern PTc and the DVD-type diffraction pattern PTd may be formed on the injection-molded base layer 20C; or both the CD-type diffraction pattern PTc and the DVD-type diffraction pattern PTd may be formed on the flat upper and lower surfaces of the base layer 20C by UV curable resin.

Furthermore, in the above-noted embodiments, the wavelengths of BD, DVD and CD are 405 nm, 650 nm, and 780 nm, respectively. The present invention is not limited to this. Other wavelengths may be applied. Alternatively, other formats may be used instead of the CD, DVD and BD types.

Furthermore, in the above-noted embodiments, the upper surface of the diffraction element 20 diffracts the CD-type optical beam Lc while the lower surface of the diffraction element 20 diffracts the DVD-type optical beam Ld. However the present invention is not limited to this. Other combination may be applied: For example, the lower surface of the diffraction element 20 diffracts the CD-type optical beam Lc while the upper surface of the diffraction element 20 diffracts the DVD-type optical beam Ld.

Furthermore, in the above-noted embodiments, the above methods are applied to the diffraction element 20 incorporated in the objective lens unit 9 of the optical pickup 7 of the optical disc apparatus 1. However the present invention is not limited to this. The methods may be applied to other diffraction elements. For example, the diffraction element 20 may be incorporated in other devices instead of the objective lens unit 9; the objective lens unit 9 may be incorporated in other devices instead of the optical pickup 7; and the optical pickup 7 may be incorporated in other devices instead of the optical disc apparatus 1.

The optical pickup and optical disc apparatus according to an embodiment of the present invention can be applied to optical elements that support various wavelengths of optical beam.

It should be understood by those skilled in the art that various modifications, combinations, sub-combinations and alterations may occur depending on design requirements and other factors insofar as they are within the scope of the appended claims or the equivalents thereof.

What is claimed is:

1. An optical pickup comprising:
a light source that emits first, second and third wavelengths of optical beam; and
an objective lens unit including a diffraction element whose one surface includes a first diffraction pattern where the first wavelength of optical beam is diffracted while the second and third wavelengths of optical beam pass through and whose other surface includes a second diffraction pattern where the second wavelength of optical beam is diffracted while the first and third wavelengths of optical beam pass through; and an objective lens that collects the first, second and third wavelengths of optical beam from the diffraction element, wherein:
the second and third wavelengths of optical beam that travels through the objective lens unit are on the optical axis of the objective lens unit while the first wavelength of the optical beam that travels through the objective lens unit have an angle with respect to the optical axis of objective lens unit; and
the first diffraction pattern is located at a position with respect to the optical axis of the objective lens unit so as to minimize aberration of the first wavelength of optical beam after being diffracted and collected by the first diffraction pattern and the objective lens.

2. The optical pickup according to claim 1, wherein
either or both the first and second diffraction patterns are produced by pressing a mold having an inverse of a shape of the first or second diffraction pattern to an ultraviolet curable resin applied to a flat surface of a base member of the diffraction element and emitting an ultraviolet ray to solidify the ultraviolet curable resin.

3. An optical disc apparatus comprising
an optical pickup that emits a first, second or third wavelength of optical beam to an optical disc, the optical pickup including:
a light source that emits the first, second and third wavelengths of optical beam; and
an objective lens unit including a diffraction element whose one surface includes a first diffraction pattern where the first wavelength of optical beam is diffracted while the second and third wavelengths of optical beam pass through and whose other surface includes a second diffraction pattern where the second wavelength of optical beam is diffracted while the first and third wavelengths of optical beam pass through; and an objective lens that collects the first, second and third wavelengths of optical beam from the diffraction element, wherein:
the second and third wavelengths of optical beam that travels through the objective lens unit are on the optical axis of the objective lens unit while the first wavelength of the optical beam that travels through the objective lens unit have an angle with respect to the optical axis of objective lens unit; and
the first diffraction pattern is located at a position with respect to the optical axis of the objective lens unit so as to minimize aberration of the first wavelength of optical beam after being diffracted and collected by the first diffraction pattern and the objective lens.
